(19) United States
(12) Patent Application Publication
(10) Pub. No.: US 2025/0279915 A1
(43) Pub. Date: Sep. 4, 2025

(54) ITERATIVE EQUALIZATION

(71) Applicant: MaxLinear, Inc., Carlsbad, CA (US)

(72) Inventor: Sridhar Ramesh, Carlsbad, CA (US)

(73) Assignee: MaxLinear, Inc., Carlsbad, CA (US)

(21) Appl. No.: 19/067,710

(22) Filed: Feb. 28, 2025

Related U.S. Application Data
(60) Provisional application No. 63/560,463, filed on Mar. 1, 2024.

(51) Int. Cl. H04L 25/03

(52) U.S. Cl. CPC H04L 25/03057; H04L 25/03159

(57) ABSTRACT

Technology disclosed herein may include a digital receiver. The digital receiver may include a processing device. The processing device may receive, at the digital receiver, a signal comprising a symbol. The processing device may perform, at the digital receiver, a first equalization operation using a partial equalizer. The processing device may detect, at the digital receiver, a symbol value of the symbol using soft slicer detection based on the first equalization operation. The processing device may compute, at the digital receiver, a deferred decision based on the symbol value.

### RELATED APPLICATION

This application claims the benefit of U.S. Provisional Application No. 63/560,463, filed Mar. 1, 2024, the disclosure of which is incorporated herein by reference in its entirety.

The examples discussed in the present disclosure are related to digital receivers and associated methods for equalization.

### BACKGROUND

Unless otherwise indicated herein, the materials described herein are not prior art to the claims in the present application and are not admitted to be prior art by inclusion in this section.

Digital communication systems map discrete symbols which may be modulated and transmitted as signals. The communication channel may impart noise, non-linear characteristics, and dispersion on the signal as the signal travels through the communication medium. The receiver may attempt to recover the signal embedded within the noise and other impairments. Methods for recovering the signal while balancing power constraints and performance constraints may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A method may include one or more of: receiving, at a receiver, a signal comprising a symbol; performing, at the receiver, a first equalization operation using a partial equalizer; detecting, at the receiver, a symbol value of the symbol using soft slicer detection based on the first equalization operation; computing, at the receiver, a deferred decision based on the symbol value; detecting, at the receiver, the symbol using a hard decision when the deferred decision indicates the symbol value is in a hard decision region; performing, at the receiver, a second equalization operation when the deferred decision indicates the symbol value is in a deferred decision region; and/or detecting, at the receiver, the symbol using hard slicer detection based on the second equalization operation.

A digital receiver may include a processing device. The processing device may receive, at the digital receiver, a signal comprising a symbol. The processing device may perform, at the digital receiver, a first equalization operation using a partial equalizer. The processing device may detect, at the digital receiver, a symbol value of the symbol using soft slicer detection based on the first equalization operation. The processing device may compute, at the digital receiver, a deferred decision based on the symbol value.

A computer-readable storage medium may include computer executable instructions. The computer executable instructions, when executed by one or more processors, may cause a digital receiver to: receive, at the digital receiver, a signal comprising a symbol; perform, at the digital receiver, a first equalization operation using a partial equalizer; detect, at the digital receiver, a symbol value of the symbol using soft slicer detection based on the first equalization operation; and/or compute, at the digital receiver, a deferred decision based on the symbol value.

Techniques for iterative equalization may use the information obtained from symbols falling within a hard decision region after a first processing operation (e.g., a first equalization operation) to assist in resolving symbols not landing with the hard decision region following the first processing operation. This technique may be used in various non-limiting examples such as in decision feedback equalization, maximum likelihood sequence estimation, or the like.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates example graphs for digital communication systems.

FIG. 2 illustrates example graphs for receiver signal processing.

FIG. 3 illustrates an example graph for signal processing complexity.

FIG. 4 illustrates example graphs for signal processing complexity reduction.

FIG. 5 illustrates an example flow diagram for iterative equalization.

FIG. 6 illustrates an example graph for iterative equalization.

FIG. 7 illustrates an example block diagram for iterative equalization.

FIG. 8 illustrates a block diagram of an example system configured to perform iterative equalization.

FIG. 9 illustrates an example process flow for iterative equalization.

FIG. 10 illustrates an example process flow for iterative equalization.

FIG. 11 illustrates a diagrammatic representation of a machine in the example form of a computing device within which a set of instructions, for causing the machine to perform any one or more of the methods discussed herein, may be executed.

FIG. 12 illustrates an example graph for iterative equalization.

FIG. 13 illustrates an example graph for iterative equalization.

FIG. 14 illustrates an example graph for iterative equalization.

FIG. 15 illustrates an example graph for iterative equalization.

### DESCRIPTION

Receiver signal processing may involve equalization which may compensate for channel dispersion and other impairments. A digital transmitter may map a signal to transmitting symbols and transmit the signal over a communication medium. Reconstructing the signal may be performed by mapping the signal to the transmitted symbols. A simple slicer may be used by computing a minimum distance to a nominal symbol level. Maximum likelihood sequence detection may act on un-equalized or partially equalized signals.

Receiver signal processing complexity is based on the complexity of equalization. Therefore, reducing the complexity of equalization may reduce the complexity of receiver signal processing. Various tradeoffs may be made including trading complexity for receiver performance (e.g., detection probability). Partial equalization may be used to reduce complexity while sacrificing performance (e.g., detection probability). Consequently, a method for reducing complexity without sacrificing performance by using partial equalization may be useful.

Performing partial equalization and iterative equalization may reduce complexity without sacrificing performance. A digital receiver may include a processing device. The processing device may receive, at the digital receiver, a signal comprising a symbol. The processing device may perform, at the receiver, a first equalization operation using a partial equalizer. The processing device may detect, at the receiver, a symbol value of the symbol using soft slicer detection based on the first equalization operation. The processing device may compute, at the receiver, a deferred decision based on the symbol value.

In addition, information that is received by processing symbols that fall within a hard decision region may be used to resolve symbols that do not fall within the hard decision region (i.e., that fall within the deferred decision region). Some use cases may include e.g., decision feedback equalization, maximum likelihood sequence estimation, belief propagation, and/or low density parity check (LDPC) coding. In these cases, partial information (e.g., information obtained from the hard decision region) may be used to determine information that does not fall within a hard decision region. Alternatively or in addition, information that falls within a hard decision region may be used without determining information that does not fall within a hard decision region. Omitting operations that do not fall within a hard decision region may reduce processing power relative to a baseline.

These techniques for iterative equalization may be applied to numerous techniques beyond equalization, detection, and signal reconstruction. For example, these techniques may be used in classification, decoding, and quantization. In the case of classification of images and/or videos, a first pass on a low resolution image may be facilitated (e.g., the base layers with layered encoding). A conditional second pass may be facilitated if the first pass classification is not successful. In the case of decoding, iterative decoding with early termination may be provided. For example decoding may use a low density parity check decoder or a Viterbi decoder. In the case of quantization of signals/voltages, a first pass of the signals/voltages may be facilitated and then a conditional second pass may be provided if the first-pass is not successful.

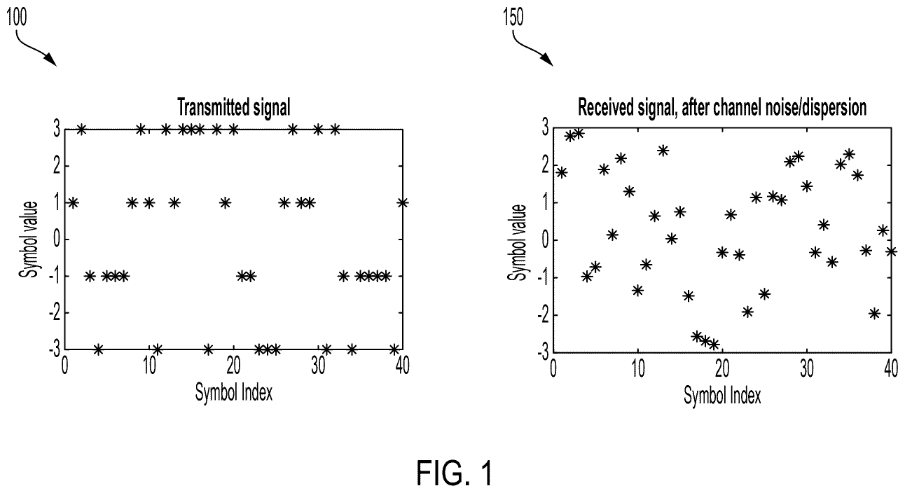

FIG. 1 illustrates example graphs for digital communication systems. Information may be mapped to discrete “symbols”, then modulated and transmitted as a signal. A graph 100 of the transmitted signal has a symbol index (e.g., ranging from 0 to 40) that is mapped to a symbol value (e.g., having a symbol value of −3, or −1, or 1, or 3). The communication channel may impart noise, non-linearity, and/or dispersion on the signal. A graph 150 of the received signal after channel noise and/or dispersion shows a symbol index (e.g., ranging from 0 to 40) and a symbol value (e.g., having a symbol value ranging between −3 and 3). The four discrete symbol values of the graph 100 have been replaced by additional values in the graph 150. The receiver may attempt to recover the signal embedded within noise and other impairments, e.g., using Pulse Amplitude Modulation in intensity modulation direct detection (IMDD)-optical communication systems.

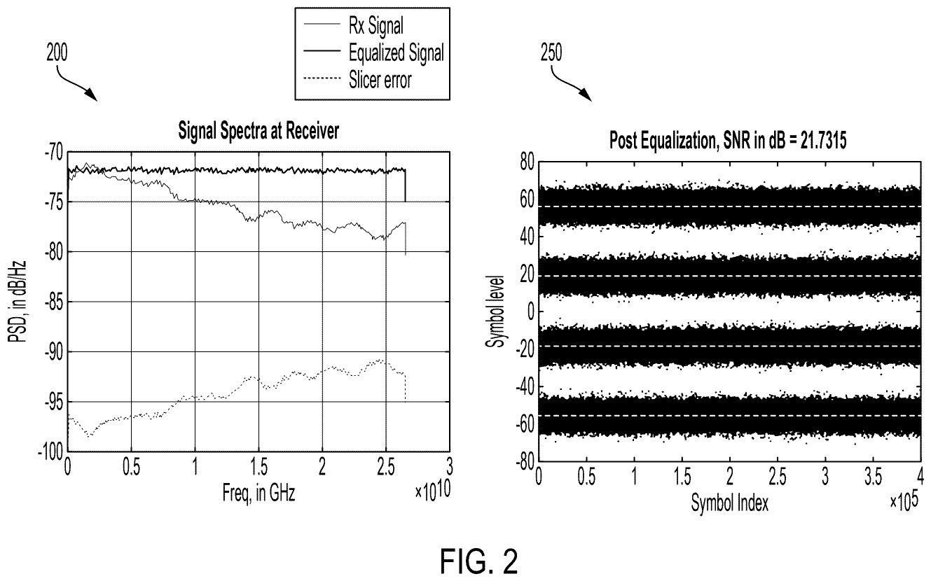

FIG. 2 illustrates example graphs 200, 250 for receiver signal processing. Equalization may compensate for channel dispersion. In graph 200, the power spectral density (PSD) in decibels per hertz (dB/Hz) is plotted against the frequency in gigahertz (GHz) to show the signal spectra at the receiver of various signals and errors. In graph 200, a received (Rx) signal is shown, an equalized signal is shown, and a slicer error is shown. In graph 250, the symbol level is plotted as a function of the symbol index in a post equalization graph in which the signal-to-noise ratio (SNR) in dB is 21.7315. Detection may be used to map the signal to the transmitted symbols. This may be accomplished using a simple slicer (e.g., using the minimum distance to nominal symbol level) or Maximum Likelihood Sequence Detection on un-equalized or partially equalized signals.

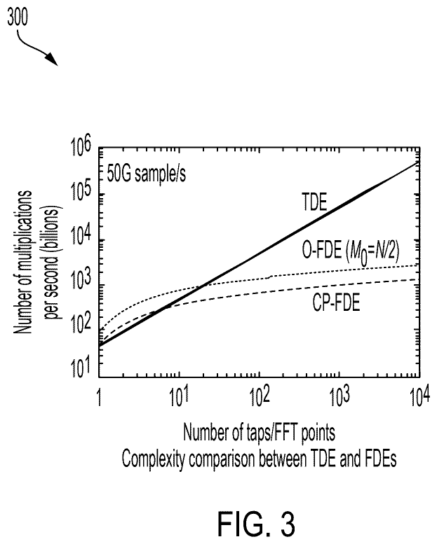

FIG. 3 illustrates an example graph 300 for signal processing complexity. In this complexity comparison between time domain equalization (TDE) and frequency domain equalization (FDE), the number of multiplications per second (in billions) was plotted as a function of the number of taps/fast Fourier transform (FFE) points. There were 50G samples per second. Three different equalizers were used. First, a TDE was shown to have a nearly linear relationship between number of taps/fast Fourier transform (FFT) points and the number of multiplications per second. Second, an overlapping frequency domain equalizer (O-FDE) having an M₀ of N/2, was shown to have a curve that flattens out. Third, a cyclic prefix frequency domain equalizer (CP-FDE) was shown to have a curve that flattens out faster than the curve for the O-FDE.

Receiver signal processing complexity may be dominated by equalization. Different types of equalizers may be used including a linear equalizer (FFE) full programmable finite impulse response (FIR) filter having a complexity of O(R×Nt×Wd×Wc) in which Rate=R, Number of taps=Nt, bit width of data=Wd, and bit width of coefficients=Wc. A time domain equalizer may be used having a complexity of time domain equalizer (TDE)—channel delay spread x signal bandwidth. A frequency domain equalizer may be used having a complexity of signal bandwidth x log (channel delay spread). For the frequency domain equalizer, the overlap FFT method for FDE may be used to determine the number of taps (e.g., FFT size a overlap size=number of taps).

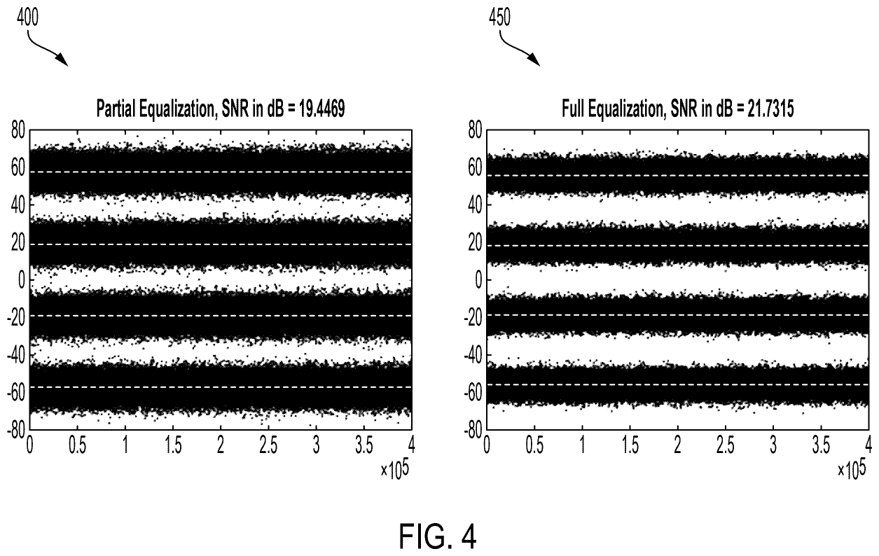

FIG. 4 illustrates example graphs 400, 450 for signal processing complexity reduction. These graphs 400, 450 show graphs 400 for partial equalization and graphs 450 for full equalization. For graphs 400, 450 symbol level is plotted as a function of symbol index. Complexity may be traded for receiver performance (detection probability). Partial equalization may leave residual inter-symbol interference (ISI), which may degrade detection probability. However, fewer operations may be used at the receiver, so power may be saved. For partial equalization, the SNR in dB may be 19.4469. For full equalization, the SNR in dB may be 21.7315.

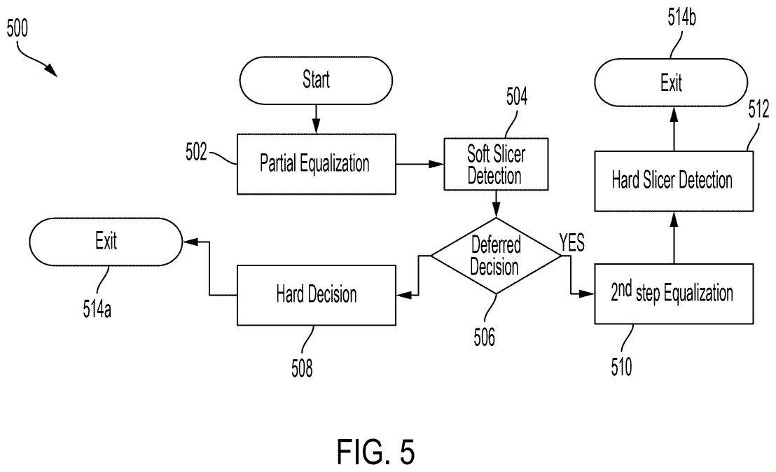

As illustrated in FIG. 5, a method 500 for iterative equalization is provided. The method 500 may include starting the method, as shown in operation 501, and: (i) receiving, at a receiver, a signal comprising a symbol; (ii) performing, at the receiver, a first equalization operation using a partial equalizer, as shown in operation 502; (iii) detecting, at the receiver, a symbol value of the symbol using soft slicer detection based on the first equalization operation, as shown in operation 504; (iv) computing, at the receiver, a deferred decision based on the symbol value, as shown in operation 506; (v) detecting, at the receiver, the symbol using a hard decision when the deferred decision indicates the symbol value is in a hard decision region, as shown in operation 508, and exiting the method, as shown in operation 514a; (vi) performing, at the receiver, a second equalization operation when the deferred decision indicates the symbol value is in a deferred decision region, as shown in operation 510; and (vii) detecting, at the receiver, the symbol using hard slicer detection based on the second equalization operation, as shown in operation 512, and exiting the method, as shown in operation 514b.

The first equalization operation may be a single tap frequency domain equalizer. Using a smaller number of taps may reduce the computational complexity of the first equalization operation. The second equalization operation may be performed using one or more of a residual feedforward equalizer, a decision feedback equalizer, or maximum likelihood sequence detection. The second equalization operation may use a simple threshold to determine the one or more symbols. The first equalization operation or the second equalization operation may be performed using various equalizers such as a linear equalizer, a time-domain equalizer, or a frequency domain equalizer.

With a time domain digital processing equalizer implementation, there may be power savings using an iterative equalization-detection approach as follows: (1) coarse feed forward equalization (FFE) may use “high magnitude” reflections to target a high percentage (˜99%) of slicer decisions on received symbols; (2) first iteration of slicer decisions may use conservative thresholds; (3) fine equalizer which may be a decision-based equalizer used to convert the unresolved symbols; and (4) second iteration of slicer decisions, using slicer thresholds.

Applying decision-based equalization in the second iteration may be facilitated because a large percentage of symbols may be resolved by then. The decisions may be leading or trailing the unresolved symbol so this is not a decision feedback equalizer (DFE) in a strict sense, but an iterative equalizer with heavy parallelism. True multipliers may be avoided by having this decision-based rather than feed-forward structure. Concerns of error propagation (where some decisions are unavailable-improbable but not impossible) may also be allayed by having an intermediate “soft decision” output. So, instead of 4 pulse amplitude modulation (PAM) levels, the lookup table (LUT) for each tap may have 7 entries. Using initial histograms and full equalization weights, firmware may determine the soft thresholds and re-determine equalizer taps for the first and second iteration. Adaptation may be performed in tracking.

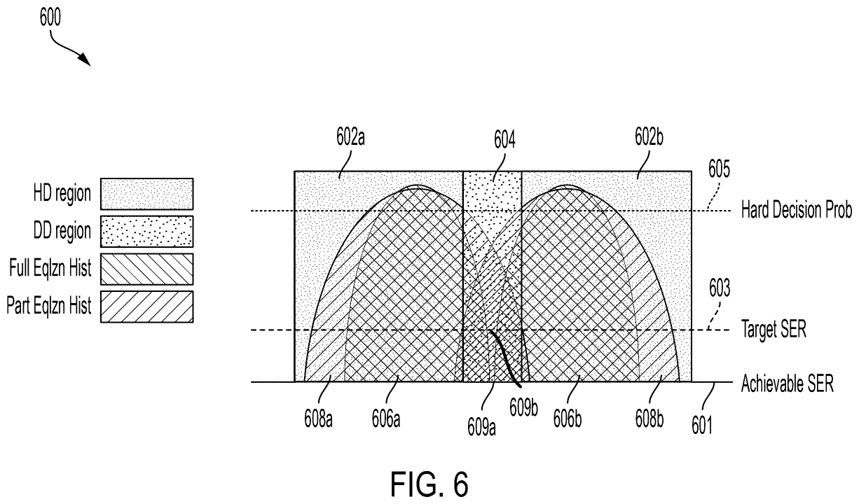

As illustrated in FIG. 6, the method may further include selecting, at the receiver, the partial equalizer based on a target performance. Alternatively or in addition, the method may further include selecting, at the receiver, the partial equalizer based on a target power level.

The graph 600 illustrated in FIG. 6 may have four regions: a hard decision (HD) region 602a, 602b, a deferred decision (DD) region 604, a full equalization histogram region 606a, 606b, and a partial equalization histogram region 608a, 608b. The full equalization histogram regions 606a, 606b may intersect with the achievable symbol error rate (SER) 601 at four points and may have a gap 609a between the inner points of intersection. When a target SER 603 is used instead of the achievable SER 601, the full histogram regions 606a, 606b may intersect with the target SER 603 at four points and may have a gap 609b between the inner points of intersection. The gap 609b between the two inner points of intersection for the target SER may be a larger gap than the gap 609a between the two inner points of intersection for the achievable SER 601.

For the partial equalization histograms 608a, 608b there may not be a gap between the inner points of intersection at the achievable SER or at the target SER. For the partial equalization histograms 608a, 608b, there may be a region of overlap between the left partial equalization histogram 608a and the right partial equalization histogram 608b. When partial equalization is used, the hard decision threshold may be set so that the left partial equalization histogram 608a does not intersect with the right partial equalization histogram 608b. By preventing intersection between the left partial equalization histogram 608a and the right partial equalization histogram 608b, the different symbols associated with the different partial equalization histograms 608a, 608b may be detected. That is, the hard decision region 602a, 602b may have a first component 602a that covers the partial equalization histogram region on the left and a second component 602b that covers the partial equalization histogram region on the right. For the region between hard decision region on the left (e.g., first component 602a) and the hard decision region on the right (e.g., second component 602b), this region may be the deferred decision region 604.

Implementation of FIG. 6 may provide a moderate performance advantage (e.g., SER˜2×) and moderate power savings (e.g., ˜40%). The hard decision probability 605 may be about 95% with the first pass equalizer having inter-symbol interference of about 1/signal-to-noise ratio (SNR).

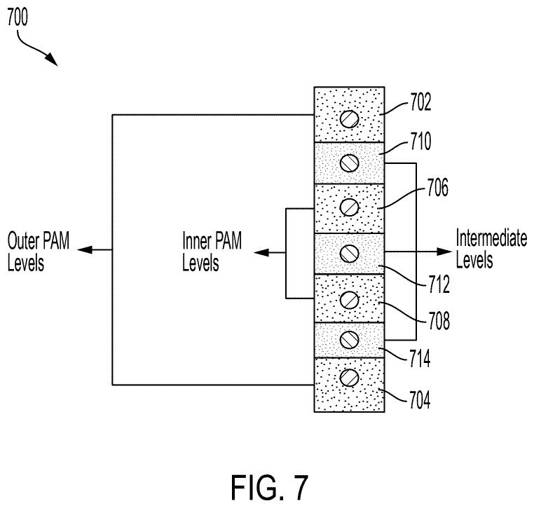

The second iteration may lead to error propagation in some cases. As illustrated in FIG. 7, the method 700 may further include performing error propagation avoidance using intermediate levels for undetermined symbols. For example, 4 pulse amplitude modulation (PAM) levels may include two outer PAM levels 702, 704 and two inner PAM levels 706, 708. To avoid error propagation (where some decisions may be unavailable), intermediate ‘soft decision’ outputs 710, 712, 714 may be used. That is, instead of 4 PAM levels, the look-up table for each tap may have 7 entries. Decision feedback equalization may be used to resolve about 90% of symbols. Error propagation avoidance may be used for the remaining 10% of symbols.

Deferred decision may be implemented in decision feedback equalization, ii) maximum likelihood sequence estimation, (iii) belief propagation and/or (iv) low density parity check (LDPC) coding. In these cases, information that falls within a hard decision region may be used to determine information that falls within a deferred decision region. In some cases, the partial information obtained from determining information that falls within a hard decision region may be adequate for the particular use case. As a result, the amount of processing may be reduced relative to a baseline and the performance (e.g., effective number of bits) may be maintained.

In some cases, iterative equalization may be applied independently of other techniques (e.g., deferred precision, deferred resolution). In other cases, iterative equalization may be applied in conjunction with other techniques (e.g., deferred precision, deferred resolution).

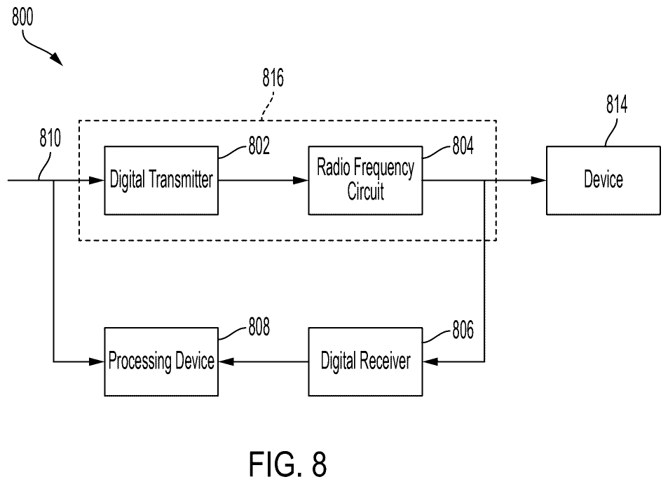

FIG. 8 illustrates a block diagram of an example communication system 800 configured for iterative equalization, in accordance with at least one example described in the present disclosure. The communication system 800 may include a digital transmitter 802, a radio frequency circuit 804, a device 814, a digital receiver 806, and a processing device 808. The digital transmitter 802 and the processing device 808 may be configured to receive a baseband signal via connection 810. A transceiver 816 may comprise the digital transmitter 802 and the radio frequency circuit 804.

In some examples, the communication system 800 may include a system of devices that may be configured to communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may be configured to communicate via one or more wireless connections. For example, the communication system 800 may include one or more devices configured to transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may be configured to obtain a baseband signal, perform one or more operations to the baseband signal to generate a modified baseband signal, and transmit the modified baseband signal, such as to one or more loads.

In some examples, the communication system 800 may include one or more communication channels that may communicatively couple systems and/or devices included in the communication system 800. For example, the transceiver 816 may be communicatively coupled to the device 814.

In some examples, the transceiver 816 may be configured to obtain a baseband signal. For example, as described herein, the transceiver 816 may be configured to generate a baseband signal and/or receive a baseband signal from another device. In some examples, the transceiver 816 may be configured to transmit the baseband signal. For example, upon obtaining the baseband signal, the transceiver 816 may be configured to transmit the baseband signal to a separate device, such as the device 814. Alternatively, or additionally, the transceiver 816 may be configured to modify, condition, and/or transform the baseband signal in advance of transmitting the baseband signal. For example, the transceiver 816 may include a quadrature up-converter and/or a digital to analog converter (DAC) that may be configured to modify the baseband signal. Alternatively, or additionally, the transceiver 816 may include a direct radio frequency (RF) sampling converter that may be configured to modify the baseband signal.

In some examples, the digital transmitter 802 may be configured to obtain a baseband signal via connection 810. In some examples, the digital transmitter 802 may be configured to up-convert the baseband signal. For example, the digital transmitter 802 may include a quadrature up-converter to apply to the baseband signal. In some examples, the digital transmitter 802 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 802.

In some examples, the transceiver 816 may include one or more subcomponents that may be used in preparing the baseband signal and/or transmitting the baseband signal. For example, the transceiver 816 may include an RF front end (e.g., in a wireless environment) which may include a power amplifier (PA), a digital transmitter (e.g., 802), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 804) of the transceiver 816 may be synchronized with the resource controller via the S-plane device, which may contribute to high-accuracy timing with respect to a reference clock.

In some examples, the transceiver 816 may be configured to obtain the baseband signal for transmission. For example, the transceiver 816 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 816 may be configured to generate a baseband signal for transmission. In these and other examples, the transceiver 816 may be configured to transmit the baseband signal to another device, such as the device 814.

In some examples, the device 814 may be configured to receive a transmission from the transceiver 816. For example, the transceiver 816 may be configured to transmit a baseband signal to the device 814.

In some examples, the radio frequency circuit 804 may be configured to transmit the digital signal received from the digital transmitter 802. In some examples, the radio frequency circuit 804 may be configured to transmit the digital signal to the device 814 and/or the digital receiver 806. In some examples, the digital receiver 806 may be configured to receive a digital signal from the RF circuit and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 816. In instances in which the processing device 808 is a standalone device or system, the processing device 808 may be configured to communicate with additional devices and/or systems remote from the processing device 808, such as the transceiver 816 and/or the device 814. For example, the processing device 808 may be configured to send and/or receive transmissions from the transceiver 816 and/or the device 814. In some examples, the processing device 808 may be combined with other elements of the communication system 800.

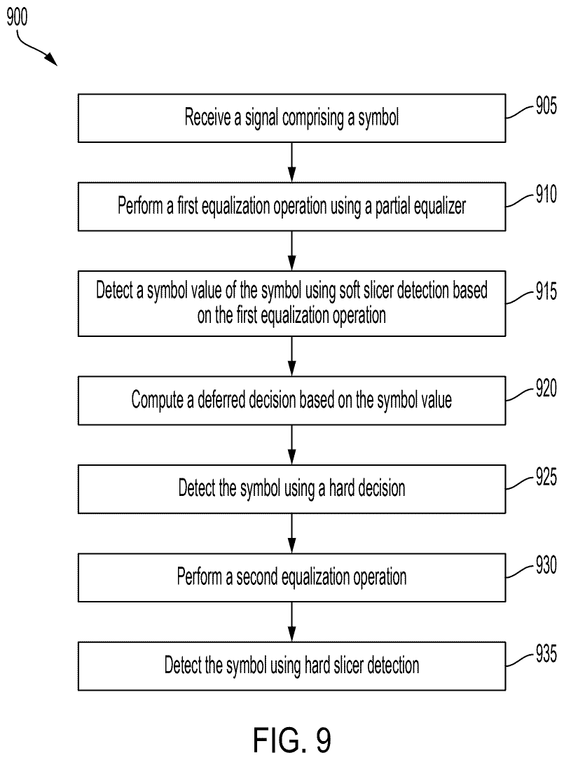

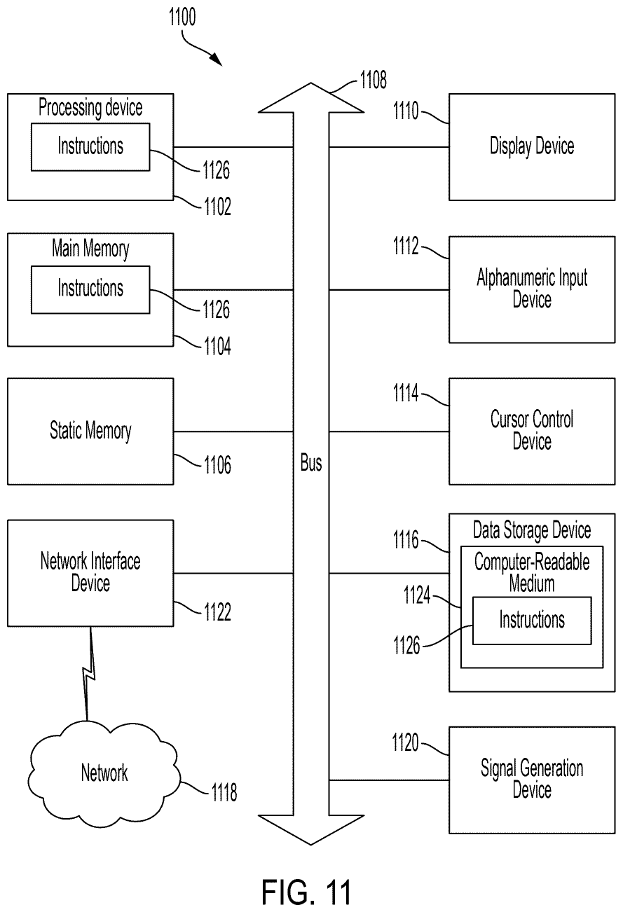

FIG. 9 illustrates a process flow of an example method 900 of iterative equalization, in accordance with at least one example described in the present disclosure. The method 900 may be arranged in accordance with at least one example described in the present disclosure. The method 900 may be performed by processing logic that may include hardware (circuitry, dedicated logic, etc.), software (such as is run on a computer system or a dedicated machine), or a combination of both, which processing logic may be included in the processor (e.g., the processing device 1102 of FIG. 11), the communication system 800 of FIG. 8, or another device, combination of devices, or systems.

The method 900 may begin at block 905 where the processing logic may receive, at a receiver, a signal comprising a symbol. At block 910, the processing logic may perform, at the receiver, a first equalization operation using a partial equalizer. At block 915, the processing logic may detect, at the receiver, a symbol value of the symbol using soft slicer detection based on the first equalization operation. At block 920, the processing logic may compute, at the receiver, a deferred decision based on the symbol value. At block 925, the processing logic may detect, at the receiver, the symbol using a hard decision when the deferred decision indicates the symbol value is in a hard decision region. At block 930, the processing logic may perform, at the receiver, a second equalization operation when the deferred decision indicates the symbol value is in a deferred decision region. At block 935, the processing logic may detect, at the receiver, the symbol using hard slicer detection based on the second equalization operation.

Modifications, additions, or omissions may be made to the method 900 without departing from the scope of the present disclosure. For example, in some examples, the method 900 may include any number of other components that may not be explicitly illustrated or described.

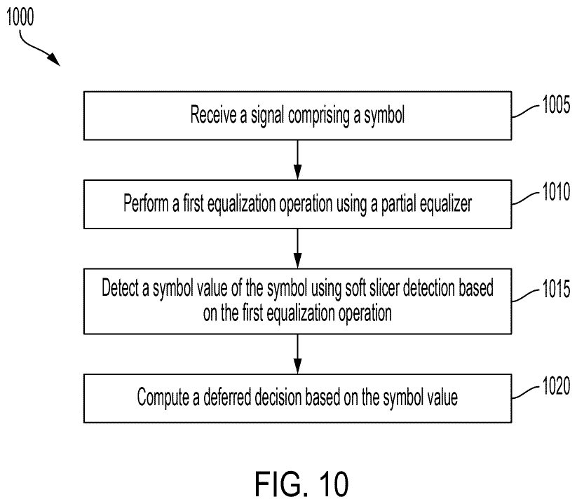

FIG. 10 illustrates a process flow of an example method 1000 of iterative equalization, in accordance with at least one example described in the present disclosure. The method 1000 may be arranged in accordance with at least one example described in the present disclosure.

The method 1000 may be performed by processing logic that may include hardware (circuitry, dedicated logic, etc.), software (such as is run on a computer system or a dedicated machine), or a combination of both, which processing logic may be included in the processor (e.g., the processing device 1102 of FIG. 11), the communication system 800 of FIG. 8, or another device, combination of devices, or systems.

The method 1000 may begin at block 1005 where the processing logic may receive, at the digital receiver, a signal comprising a symbol. At block 1010, the processing logic may perform, at the digital receiver, a first equalization operation using a partial equalizer. At block 1015, the processing logic may detect, at the digital receiver, a symbol value of the symbol using soft slicer detection based on the first equalization operation. At block 1020, the processing logic may compute, at the digital receiver, a deferred decision based on the symbol value.

Modifications, additions, or omissions may be made to the method 1000 without departing from the scope of the present disclosure. For example, in some examples, the method 1000 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 11 illustrates a diagrammatic representation of a machine in the example form of a computing device 1100 within which a set of instructions, for causing the machine to perform any one or more of the methods discussed herein, may be executed. The computing device 1100 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1100 includes a processing device 1102, a main memory 1104 (e.g., read-only memory (ROM), flash memory, dynamic random access memory (DRAM) such as synchronous DRAM (SDRAM)), a static memory 1106 (e.g., flash memory, static random access memory (SRAM)) and a data storage device 1116, which communicate with each other via a bus 1108.

Processing device 1102 represents one or more general-purpose processing devices such as a microprocessor, central processing unit, or the like. More particularly, the processing device 1102 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also include one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein.

The computing device 1100 may further include a network interface device 1122 which may communicate with a network 1118. The computing device 1100 also may include a display device 1110 (e.g., a liquid crystal display (LCD) or a cathode ray tube (CRT)), an alphanumeric input device 1112 (e.g., a keyboard), a cursor control device 1114 (e.g., a mouse) and a signal generation device 1120 (e.g., a speaker). In at least one example, the display device 1110, the alphanumeric input device 1112, and the cursor control device 1114 may be combined into a single component or device (e.g., an LCD touch screen).

The data storage device 1116 may include a computer-readable storage medium 1124 on which is stored one or more sets of instructions 1126 embodying any one or more of the methods or functions described herein. The instructions 1126 may also reside, completely or at least partially, within the main memory 1104 and/or within the processing device 1102 during execution thereof by the computing device 1100, the main memory 1104 and the processing device 1102 also constituting computer-readable media. The instructions may further be transmitted or received over a network 1118 via the network interface device 1122.

While the computer-readable storage medium 1124 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to the present disclosure.

### Example 1: Histogram of First and Second Iteration

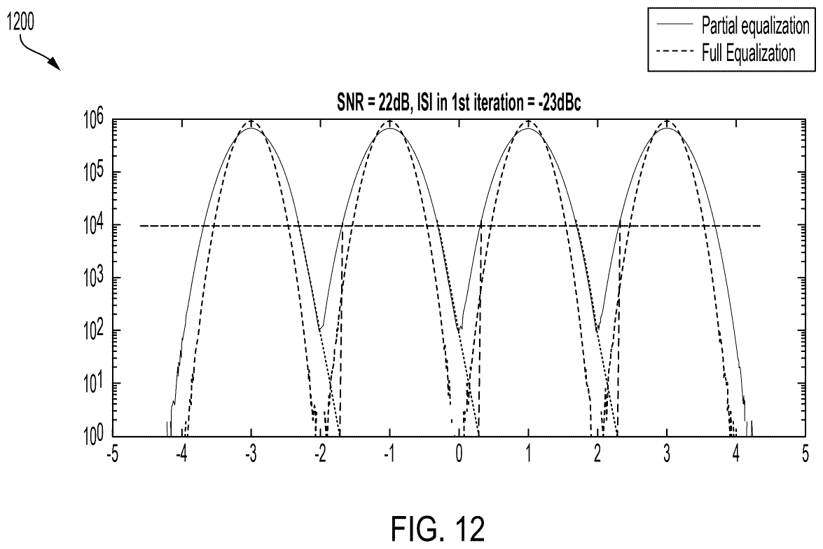

FIG. 12 illustrates an example graph 1200 for iterative equalization. Power savings may be non-deterministic, and the thresholds may be set up to incur a marginal performance penalty (e.g., <2× bit error rate (BER)). By a conservative estimate, slicer thresholds for the first iteration may be selected to ensure ˜98% decisions in the first iteration, while utilizing ˜70% of equalization power. The inter-symbol interference in the 1^{st} iteration was-23 decibels relative to the carrier (dBc). The SNR was 22 dB. The second iteration may be allowed to exceed the budget (flops, etc.), but the savings may still be significant. In this example, overall power may be P_eq_itr=P_eq_std*0.7+P_eq_std*0.02*(0.3+α)˜=P_eq_std*0.71.

In FIG. 12, the dashed lines represent the conservative slicer thresholds of the first iteration. As seen, over 99% of symbols in the first iteration (solid histograms) fall within these lines, leaving <1% to be handled in the second iteration (dashed curve histograms), thus accomplishing a much lower overall BER than by engaging partial equalization without a second iteration.

### Example 2: Power Modes

Table 1 is an example table for iterative equalization. The table shows equalization modes for various power modes. Electrical receiver (ERX) taps and optical receiver (ORX) taps are shown. 4 floating taps may account for ˜25% of each FFE. Overall power of 10 floating taps may be roughly 50% of the power of the FFE. The tap coefficients may play a role in the precise power consumption of the partial equalizer. Performance degradation may be avoided by applying the second iteration to a small percentage of symbols remaining unresolved after the first.

TABLE 1
Power Modes

| | | ERX Taps | | | ORX Taps | | |
|---|---|---|---|---|---|---|---|
| typ | typ | (10, 0) | (10, 4) | (10, 8) | (10, 0) | (10, 4) | (10, 8) |
| −1240 | −889 | 1 | | | 1 | | |
| 160 | 160 | | 1 | | | 1 | |
| 1150 | 912 | | | 1 | | | 1 |
| Power of | | −110 | 0 | 110 | −110 | 0 | 110 |
| Function | | | | | | | |
| | min | −110 | 0 | 0 | −110 | 0 | 0 |
| | def | 0 | 0 | 0 | 0 | 0 | 0 |
| | max | 0 | 0 | 110 | 0 | 0 | 110 |

| | | | | |
|---|---|---|---|---|
| Performance | 0 | +0.3 dB | 0 | +0.3 dB |
| Impact | | SNR | | SNR |

### Example 3: Equalization Complexity Vs. Performance

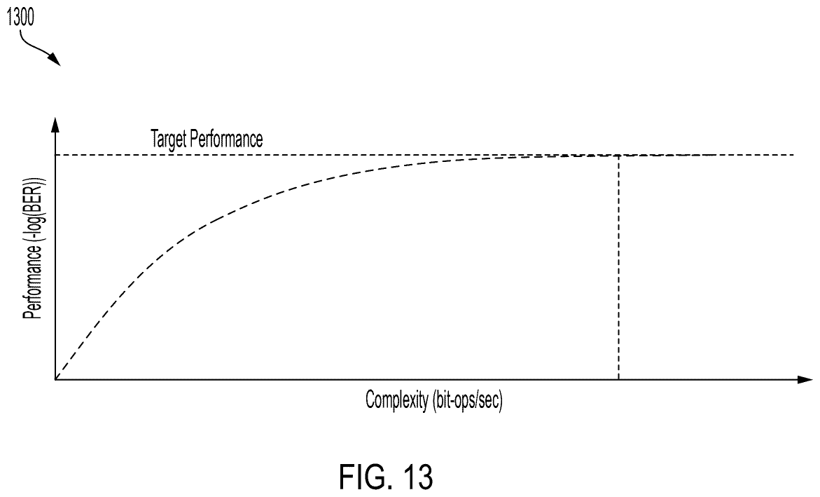

FIG. 13 illustrates an example graph 1300 for iterative equalization. The graph 1300 has complexity in bit operations per second on the x-axis and performance in terms of the negative logarithm of the BER on the y-axis. There may be a trend of diminishing returns.

### Example 4: Comparison Among Equalization, First-Pass Equalization, and Iterative Equalization

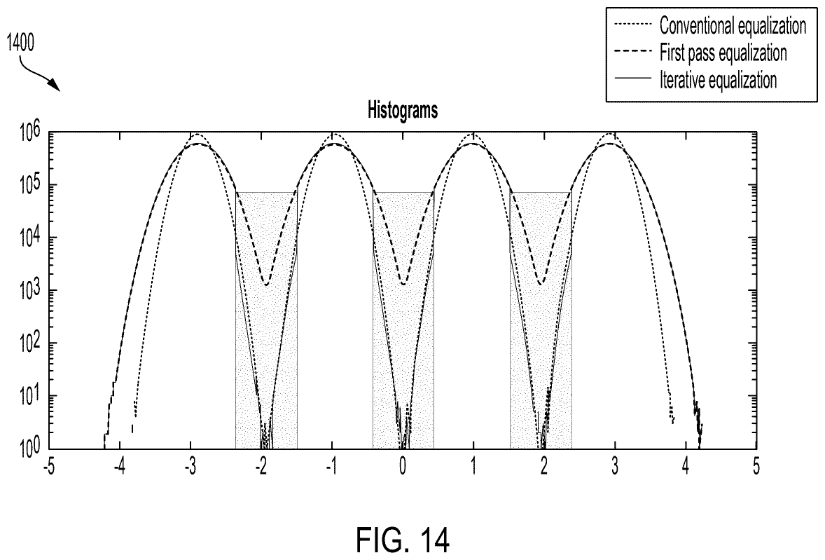

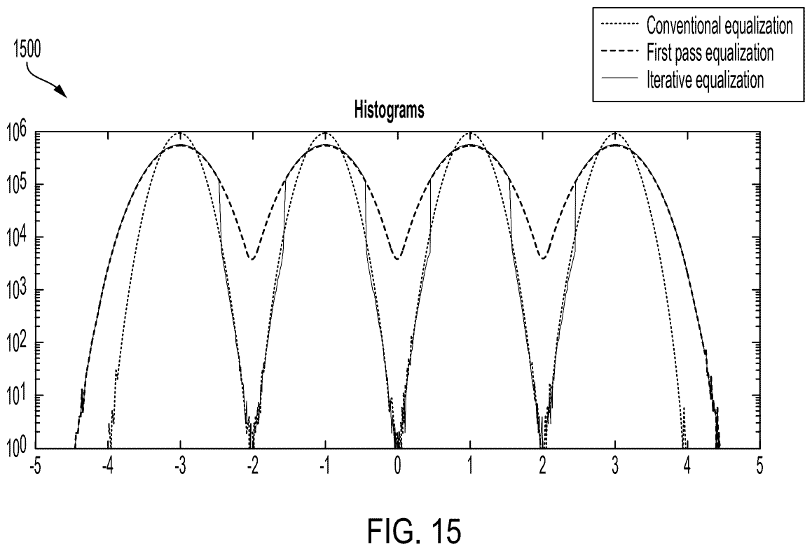

FIGS. 14 and 15 illustrate example graphs 1400, 1500 for iterative equalization. The soft decision region was 55%. The first pass equalization inter-symbol interference was about 0.33/SNR. The power savings was about 55%. The BER performance was about 1× (i.e., 2.9×10⁻⁸ vs. 2.7×10⁻⁸). As illustrated in FIG. 15, iterative equalization may be the addition of first-pass equalization before a partition and full equalization after the partition.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A method comprising:
receiving, at a receiver, a signal comprising a symbol;
performing, at the receiver, a first equalization operation using a partial equalizer;
detecting, at the receiver, a symbol value of the symbol using soft slicer detection based on the first equalization operation;
computing, at the receiver, a deferred decision based on the symbol value;
detecting, at the receiver, the symbol using a hard decision when the deferred decision indicates the symbol value is in a hard decision region;
performing, at the receiver, a second equalization operation when the deferred decision indicates the symbol value is in a deferred decision region; and
detecting, at the receiver, the symbol using hard slicer detection based on the second equalization operation.

2. The method of claim 1, further comprising performing, at the receiver, the first equalization operation using a single tap frequency domain equalizer.

3. The method of claim 1, further comprising performing, at the receiver, the second equalization operation using one or more of a residual feedforward equalizer, a decision feedback equalizer, or maximum likelihood sequence detection.

4. The method of claim 1, further comprising performing, at the receiver, the second equalization operation using a simple threshold.

5. The method of claim 1, further comprising performing, at the receiver, error propagation avoidance using intermediate levels for undetermined symbols.

6. The method of claim 1, further comprising performing, at the receiver, one or more of the first equalization operation or the second equalization operation using one or more of a time domain equalizer or a frequency domain equalizer.

7. The method of claim 1, further comprising selecting, at the receiver, the partial equalizer based on a target performance.

8. The method of claim 1, further comprising selecting, at the receiver, the partial equalizer based on a target power level.

9. A digital receiver, comprising:
a processing device operable to:
receive, at the digital receiver, a signal comprising a symbol;
perform, at the digital receiver, a first equalization operation using a partial equalizer;
detect, at the digital receiver, a symbol value of the symbol using soft slicer detection based on the first equalization operation;
compute, at the digital receiver, a deferred decision based on the symbol value.

10. The digital receiver of claim 9, wherein the processing device is further operable to:
perform, at the digital receiver, the first equalization operation using a single tap frequency domain equalizer.

11. The digital receiver of claim 9, wherein the processing device is further operable to:
detect, at the digital receiver, the symbol using a hard decision when the deferred decision indicates the symbol value is in a hard decision region.

12. The digital receiver of claim 9, wherein the processing device is further operable to:
perform, at the digital receiver, a second equalization operation when the deferred decision indicates the symbol value is in a deferred decision region.

13. The digital receiver of claim 12, wherein the processing device is further operable to:
detect, at the digital receiver, the symbol using hard slicer detection based on the second equalization operation.

14. The digital receiver of claim 12, wherein the processing device is further operable to:
perform, at the digital receiver, the second equalization operation using one or more of a residual feedforward equalizer, a decision feedback equalizer, or maximum likelihood sequence detection.

15. The digital receiver of claim 12, wherein the processing device is further operable to:
perform, at the digital receiver, the second equalization operation using a simple threshold.

16. The digital receiver of claim 9, wherein the processing device is further operable to:
perform, at the receiver, error propagation avoidance using intermediate levels for undetermined symbols.

17. A computer-readable storage medium including computer executable instructions that, when executed by one or more processors, cause a digital receiver to:
receive, at the digital receiver, a signal comprising a symbol;
perform, at the digital receiver, a first equalization operation using a partial equalizer;
detect, at the digital receiver, a symbol value of the symbol using soft slicer detection based on the first equalization operation;
compute, at the digital receiver, a deferred decision based on the symbol value.

18. The computer-readable storage medium of claim 17, wherein the instructions, when executed by the one or more processors, further cause the digital receiver to:
detect, at the digital receiver, the symbol using a hard decision when the deferred decision indicates the symbol value is in a hard decision region.

19. The computer-readable storage medium of claim 17, wherein the instructions, when executed by the one or more processors, further cause the digital receiver to:
perform, at the digital receiver, a second equalization operation when the deferred decision indicates the symbol value is in a deferred decision region.

20. The computer-readable storage medium of claim 19, wherein the instructions, when executed by the one or more processors, further cause the digital receiver to:
detect, at the digital receiver, the symbol using hard slicer detection based on the second equalization operation.
